(19) United States
(12) Patent Application Publication
(10) Pub. No.: US 2010/0330449 A1
(43) Pub. Date: Dec. 30, 2010

(54) FUEL CELL SYSTEM AND STACK THEREOF

(76) Inventors: Seong-Jin An, Yongin-si (KR); Chi-Seung Lee, Yongin-si (KR); Jun-Young Park, Yongin-si (KR); Jin-Hwa Lee, Yongin-si (KR); Jun-Won Suh, Yongin-si (KR)

Correspondence Address: CHRISTIE, PARKER & HALE, LLP, PO BOX 7068, PASADENA, CA, 91109-7068, US

(21) Appl. No.: 12/792,021

(22) Filed: Jun. 2, 2010

(30) Foreign Application Priority Data
Jun. 25, 2009 (KR) 10-2009-0057233

(51) Int. Cl. H01M 8/04; H01M 8/24

(52) U.S. Cl. 429/434; 429/456; 429/457

(57) ABSTRACT

A fuel cell system includes a fuel supply, an air supply, a plurality of unit cells being stacked, and a stack. The stack includes: a plurality of unit cells, each comprising separators and a membrane assembly (MEA) disposed between the separators; a fuel inlet configured to introduce a fuel to the unit cell; an unreacted fuel outlet configured to emit unreacted fuel from the stack; a fuel bypass path; a fuel distribution path configured to distribute the fuel to each of the unit cells; and an unreacted fuel inducing path configured to channel the unreacted fuel to the unreacted fuel outlet.

### CROSS-REFERENCE TO RELATED APPLICATION

This application claims priority to and the benefit of Korean Patent Application No. 10-2009-0057233, filed in the Korean Intellectual Property Office on Jun. 25, 2009, the entire content of which is incorporated herein by reference.

### BACKGROUND

1. Field

The following description relates to a fuel cell system with a fuel inlet and a fuel outlet that are formed on the same side of a stack of unit cells.

2. Description of the Related Art

A fuel cell system, for example, a polymer electrolyte membrane fuel cell (PEMFC) system uses a polymer electrolyte member having a hydrogen ion exchange capability. Here, the PEMFC system selectively transmits hydrogen generated by reforming a hydrocarbon-based fuel such as methanol or natural gas and oxygen contained in the air to the polymer electrolyte member to generate power and heat through electrochemical reaction between the hydrogen and the oxygen. The fuel cell system includes a stack formed by stacking a plurality of unit cells that substantially produce power and heat.

Each unit cell in the stack includes a membrane electrode assembly (MEA) that is composed of an anode, a cathode, a polymer electrolyte membrane between the anode and cathode, and a separator having a fuel path and an air path. A fuel containing hydrogen is supplied to the anode through the fuel path, and air containing oxygen is supplied to the cathode through the air path. The separators form the fuel path and the air path, and connect the anode of one MEA and a cathode of another MEA in series.

Therefore, the stack includes inlets and outlets for supplying the fuel and air and emitting unreacted fuel and air. That is, the fuel inlet and the fuel outlet form a fuel flow path length there between, and the air inlet and the air outlet form an air flow path length there between.

When the inlets and the outlets are respectively formed at different sides of the stack, the respective unit cells have the same fuel flow path lengths and the same air flow path lengths.

However, in the case that the inlet and the outlet are formed in the same side of the stack in order to increase spatial utility of the stack, fuel flow path lengths of the respective unit cells are different from each other and air flow path lengths of the respective unit cells are also different from each other. Accordingly, the supply of fuel and air to the unit cells is not uniform.

The above information disclosed in this Background section is only for enhancement of understanding of the background of the invention and therefore it may contain information that does not form the prior art that is already known in this country to a person of ordinary skill in the art.

### SUMMARY

Aspects embodiments of the present invention are directed toward a fuel cell system and a stack that is capable of allowing the fuel supplied to each unit cell uniform by equalizing the fuel flow path length of each unit cell in the case that a fuel inlet and a fuel outlet are formed in the same side of a stack.

Aspects of the present invention are directed toward a fuel cell system and a stack that makes the fuel and air supply to each unit cell uniform by equalizing the length of the fuel path and the air path to each unit cell in the case that a fuel inlet and a fuel outlet are formed in the same side of a stack.

According to one embodiment, a fuel cell system includes: a fuel supply configured to supply a fuel containing hydrogen; an air supply configured to supply air containing oxygen; and a stack configured to generate power and heat through an electrochemical reaction of the hydrogen and the oxygen.

The stack includes: a plurality of unit cells stacked together, and each unit cell of the plurality of unit cells includes separators and a membrane assembly (MEA) disposed between the separators; a fuel inlet coupled to the fuel supply at a first end of the stack, the fuel inlet configured to introduce the fuel to the plurality of the unit cells; an unreacted fuel outlet at the first end of the stack, the unreacted fuel outlet configured to emit unreacted fuel from the stack; a fuel bypass path coupled to the fuel inlet, the fuel bypass path configured to bypass the fuel from the first end of the stack to be at a second end of the stack; a fuel distribution path coupled to the fuel bypass path at the second end of the stack and configured to distribute the fuel to the plurality of unit cells; and an unreacted fuel inducing path coupled between the fuel distribution path and the unreacted fuel outlet, the unreacted fuel path configured to channel the unreacted fuel to the unreacted fuel outlet.

The fuel bypass path is formed by a connection of fuel bypass holes in a portion of the separators that extends past the MEA.

The fuel distribution path is formed by a connection of fuel supply holes in a portion of the separators that extends past the MEA, and the fuel supply holes are coupled to a first side of fuel paths of the separators.

The unreacted fuel inducing path is formed by a connection of fuel outlet holes in the portion of the separators that extends past the MEA, and the fuel outlet holes are coupled to a second side of the fuel paths of the separators.

The fuel bypass path and the fuel distribution path are coupled together through a first communication groove in at least one of an end plate, an insulator, a current collecting plate, and a separator in the an outermost unit cell of the plurality of unit cells at the second end of the stack.

The stack further includes: an air inlet configured to introduce air to the plurality of unit cells from the air supply; an unreacted air outlet located at a side of the stack opposite to a side of the stack where the air inlet is located; and a reaction cooling air path extending between the air inlet and the unreacted air outlet, the reaction cooling air path configured to distribute the unreacted air to the unit cells and form air flow paths for heat dissipation.

The reaction cooling air path is formed to extend in a direction crossing the extension direction of the fuel bypass path.

The reaction cooling air path is on a side of a corresponding separator of the separators opposite to a side of the corresponding separator disposed thereon by a fuel path.

A first separator of the separators of each unit cell includes a fuel path adjacent to one side of the MEA, and a second separator of the separators includes the reaction cooling air path adjacent to another side of the MEA.

According to another embodiment of the present invention, a fuel cell system includes: a fuel supply configured to supply a fuel containing hydrogen; an air supply configured to supply air containing oxygen; and a stack configured to generate power and heat through an electrochemical reaction of the hydrogen and the oxygen, wherein the stack includes: a plurality of unit cells stacked together, and each of the plurality of unit cells includes separators and a membrane assembly (MEA) disposed between the separators; a fuel inlet coupled to the fuel supply, the fuel inlet configured to introduce the fuel to the plurality of unit cells; an unreacted fuel outlet configured to emit unreacted fuel from the stack; an air inlet coupled to the air supply, the air inlet configured to introduce the air from the air supply to the plurality of unit cells; and an unreacted air outlet configured to emit unreacted air from the stack, wherein the fuel inlet, the unreacted fuel outlet, the air inlet, and the unreacted air outlet are formed in at a first end of the stack; a fuel bypass path coupled to the fuel inlet, the fuel bypass path configured to bypass the fuel from the first end of the stack to be at a second end of the stack; a fuel distribution path coupled to the fuel bypass path at the second end of the stack, and configured to distribute the fuel to each of the plurality of unit cells; and an unreacted fuel inducting path coupled between the fuel distribution path and the unreacted fuel outlet, the unreacted fuel path configured to channel the unreacted fuel to the unreacted fuel outlet.

The stack further includes: an air bypass path coupled to the air inlet, the air bypass path configured to bypass the air from the first end of the stack to be at the second end of the stack; an air distribution path coupled to the air bypass path at the second end of the stack, the air distribution path configured to distribute air to each of the plurality unit cells; and an unreacted air inducing path coupled between the air distribution path and the unreacted air outlet, the unreacted air inducing path configured to channel the unreacted air to the unreacted air outlet.

The fuel bypass path includes a connection of fuel bypass holes in portions of the separators that extend past the MEA, and the air bypass path includes a connection of air bypass holes in portions of the separators that extend past the MEA.

The fuel distribution path is formed by a connection of fuel supply holes in a portion of the separators that extend past the MEA, and the fuel supply holes are coupled to a first side of fuel paths of the separators.

The unreacted fuel inducing path is formed by a connection of fuel outlet holes in the portion of the separators that extends past the MEA, and the fuel outlet holes are coupled to a second side of the fuel paths of the separators.

The air distribution path is formed by a connection of air supply holes in a portion of the separators that extends past the MEA, and the air supply holes are coupled to a first side of air paths in the separators.

The unreacted air inducing path is formed by a connection of air outlet holes in the portion of the separators that extends past the MEA, and the air outlet holes are coupled to a second side of the air paths in the separators.

The air bypass path and the air distribution path are coupled together through a second communication groove formed in at least one of an end plate, an insulator, a current collecting plate, and a separator in an outermost unit cell of the plurality of unit cells at the second end of the stack.

According to another embodiment of the present invention, a fuel cell system includes: a plurality of unit cells stacked together, each of the plurality of unit cells including separators and a membrane assembly (MEA) disposed between the separators; a fuel inlet coupled to a first end of the stack and configured to introduce a fuel containing hydrogen to the unit cells; an unreacted fuel outlet coupled to the first end of the stack and configured to emit unreacted fuel from the unit cells; a fuel bypass path coupled to the fuel inlet, the fuel bypass path configured to bypass the fuel from the first end of the stack to be at a second end of the stack; a fuel distribution path coupled to the fuel bypass path at the second end of the stack and configured to distribute the fuel to the plurality of unit cells; and an unreacted fuel inducing path coupled between the fuel distribution path and the unreacted fuel outlet, the unreacted fuel path configured to channel the unreacted fuel to the unreacted fuel outlet.

The fuel bypass path includes a connection of fuel bypass holes in a portion of the separators that extends past the MEA.

The fuel distribution path includes a connection of fuel supply holes in a portion of the separators that extends past the MEA, and the fuel supply holes are coupled to a first side of fuel paths of the separators.

The unreacted fuel inducting path is formed by a connection of fuel outlet holes in the portion of the separators that extends past the MEA, and the fuel outlet holes are coupled to a second side of the fuel paths of the separators.

The fuel bypass path and the fuel distribution path are coupled together through a first communication groove in at least one of an end plate, an insulator, a current collecting plate, and a separator in the an outermost unit cell of the plurality of unit cells at the second end of the stack.

The stack further includes: an air inlet configured to introduce air to the plurality of unit cells from the air supply; an unreacted air outlet located at a side of the stack opposite to a side of the stack where the air inlet is located; and a reaction cooling air path extending between the air inlet and the unreacted air outlet, the reaction cooling air path formed in the crossing direction of the fuel bypass path and configured to distribute the unreacted air to the unit cells and form air flow paths for heat dissipation.

According to another embodiment of the present invention, a fuel cell system includes: a stack configured to generate power and heat through an electrochemical reaction of the hydrogen and the oxygen, the stack including: a plurality of unit cells stacked together, and each of the plurality of unit cells includes separators and a membrane assembly (MEA) disposed between the separators; a fuel inlet coupled to the fuel supply, the fuel inlet configured to introduce a fuel to the plurality of unit cells; an unreacted fuel outlet configured to emit unreacted fuel from the stack; an air inlet coupled to the air supply, the air inlet configured to transfer air from the air supply to the unit cells; and an unreacted air outlet configured to emit unreacted air from the stack, wherein the fuel inlet, the unreacted fuel outlet, the air inlet, and the unreacted air outlet are formed at a first end of the stack; a fuel bypass path coupled to the fuel inlet, the fuel bypass path configured to bypass the fuel from the first end of the stack to be at a second end of the stack; a fuel distribution path coupled to the fuel bypass path at the second end of the stack, and configured to distribute the fuel to each of the plurality of unit cells; and an unreacted fuel inducing path coupled to the fuel distribution path and the unreacted fuel outlet, the unreacted fuel inducing path configured to channel the unreacted fuel to the unreacted fuel outlet.

The fuel cell system may further include: an air bypass path coupled to the air inlet, the air bypass path configured to bypass the air from the first end of the stack to be at the second end of the stack; an air distribution path coupled to the air bypass path at the second end of the stack, the air distribution path configured to distribute air to each of the plurality of unit cells; and an unreacted air inducing path coupled between the air distribution path and the unreacted air outlet, the unreacted air inducing path configured to channel the unreacted air to the unreacted air outlet.

The fuel bypass path may further include a connection of fuel bypass holes in portions of the separators that extend past the MEA and the air bypass path includes a connection of air bypass holes in portions of the separators that extend past the MEA.

The fuel distribution path is formed by a connection of fuel supply holes in a portion of the separators that extends past the MEA, the fuel supply holes are coupled to a first side of fuel paths of the separators, the unreacted fuel inducing path is formed by a connection of fuel outlet holes in the portion of the separators that extends past the MEA, and the fuel outlet holes are coupled to a second side of the fuel paths of the separators.

The air distribution path is formed by a connection of air supply holes in a portion of the separators that extends past the MEA, the air supply holes are coupled to a first side of air paths of the separators, the unreacted air inducing path is formed by a connection of air outlet holes in the portion of the separators that extends past the MEA, and the air outlet holes are coupled to a second side of the air paths in the separators.

The air bypass path and the air distribution path are coupled through a second communication groove formed in at least one of an end plate, an insulator, a current collecting plate, and a separator in an outermost unit cell of the plurality of unit cells at the second end of the stack.

According to exemplary embodiments of the present invention, fuel that is bypass-supplied through the fuel bypass path can be distributed to the respective unit cells through the fuel distribution path, and unreacted fuel is induced through the unreacted fuel inducting path and can be emitted from the respective unit cells so that the fuel flow path lengths of the respective unit cells can be equal to each other even though the fuel inlet and the unreacted fuel outlet are formed in the same side of the stack. Therefore, the fuel supply amount supplied to the respective unit cells can be uniform.

These and other features, aspects, and embodiments are described below in the section entitled “Detailed Description.”

### BRIEF DESCRIPTION OF THE DRAWINGS

The above and other aspects and features of the embodiments according to the present invention will be more clearly understood from the following detailed description taken in conjunction with the accompanying drawings, in which:

FIG. 1 is a schematic diagram of a fuel cell system according to a first exemplary embodiment of the present invention.

FIG. 2 is a perspective view of a stack as shown in FIG. 1.

FIG. 3 is an exploded perspective view of a portion of a stack as shown in FIG. 2.

FIG. 4 is an exploded perspective view of a portion of a stack as shown in FIG. 2.

FIG. 5 is a top plan view of a separator of a unit cell as shown in FIG. 4, corresponding to the MEA.

FIG. 6 is an exploded perspective view of an end plate, an insulator, and a current collecting plate of a portion of a stack as shown in FIG. 2.

FIG. 7 shows a schematic diagram of a fuel cell system according to a second exemplary embodiment of the present invention.

FIG. 8 is a perspective view of a portion of a stack as shown in FIG. 7.

FIG. 9 is an exploded perspective view of a portion of a stack as shown in FIG. 8.

FIG. 10 is an exploded perspective view of a unit cell of a portion of a stack as shown in FIG. 8.

FIG. 11 is a top plan view of an anode-side separator of the unit cell as shown in FIG. 10, corresponding to the MEA.

FIG. 12 is a top plan view of a cathode-side separator of the unit cell as shown in FIG. 10, corresponding to the MEA.

FIG. 13 shows an exploded perspective view of an end plate, an insulator, and a current collecting plate of the stack as shown in FIG. 8.

### DESCRIPTION OF REFERENCE NUMERALS INDICATING CERTAIN ELEMENTS IN THE DRAWINGS

100, 200: fuel cell system
10: fuel supply
11: reformer
20: air supply
21: air pump
30, 230: stack
31: MEA
32, 232: anode-side separator
33, 233: cathode-side separator
321: fuel path
322, 323, 2332, 2333: connector
2331: air path
34, 234: gasket
41: fastening member
42, 242: current collecting plate
43, 243: insulator
421, 431, 422, 432: fuel bypass hole
2421, 2431: air bypass hole
44, 244: end plate
51, 251: fuel inlet
52, 252: unreacted fuel outlet
53, 253: fuel bypass path
54: fuel distribution path
541: fuel supply hole
55: unreacted fuel inducing path
551: fuel outlet hole
61, 261: air inlet
62, 262: unreacted air outlet
63: reaction cooling air path
263: air bypass path
264: air distribution path
265: unreacted air inducing path
2631: air bypass hole
2641: air supply hole
2651: air outlet hole
71, 72: first and second communication

### DETAILED DESCRIPTION

Hereinafter, with reference to the accompanying drawings, certain exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

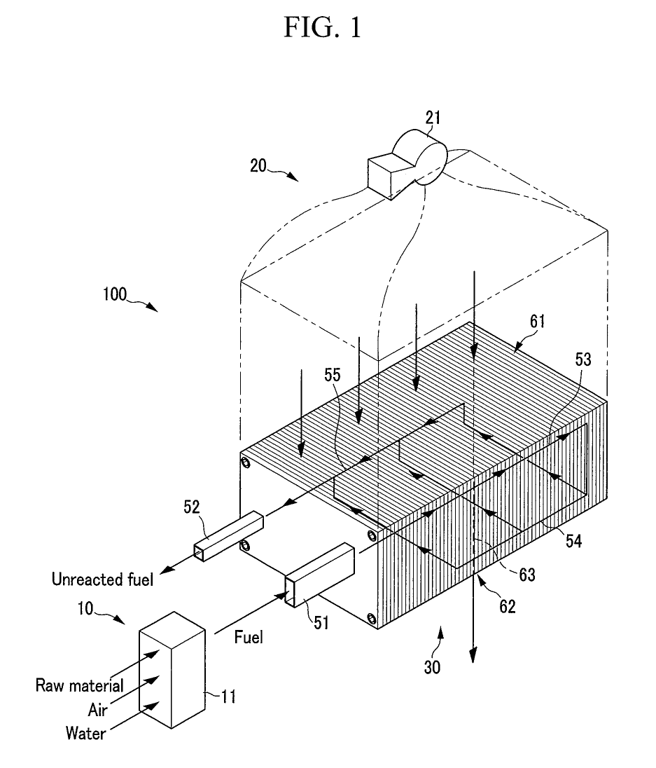

FIG. 1 is a schematic diagram of a fuel cell system according to a first exemplary embodiment of the present invention. Referring to FIG. 1, a fuel cell system (hereinafter referred to as a system) 100 includes a fuel supply 10 for supplying a fuel containing hydrogen, an air supply 20 for supplying air containing oxygen, and a stack 30 configured to generate power and heat through an electrochemical reaction between the hydrogen and the oxygen.

For example, the fuel supply 10 reforms a liquid fuel in a reformer 11 to generate hydrogen gas using a hydrogen containing liquid fuel such as methanol, ethanol, or natural gas supplied from a fuel tank by driving of a fuel pump, and then supplies the generated hydrogen gas to the stack 30.

The fuel supply 10 may supply the liquid fuel containing hydrogen directly to the stack 30, and in this case, the reformer 11 may be omitted. For convenience, the fuel supplied from the fuel supply 10 to the stack 30 is referred to as hydrogen gas. Therefore, the fuel supply 10 supplies e.g., hydrogen gas to the stack 30.

The air supply 20 supplies oxygen-containing air to the stack 30 by driving an air pump 21. The air supplied from the air supply 20 and the fuel supplied from the fuel supply 10 are independently supplied to the stack 30 and undergo an oxidation reaction and a reduction reaction while being circulated in the stack 30.

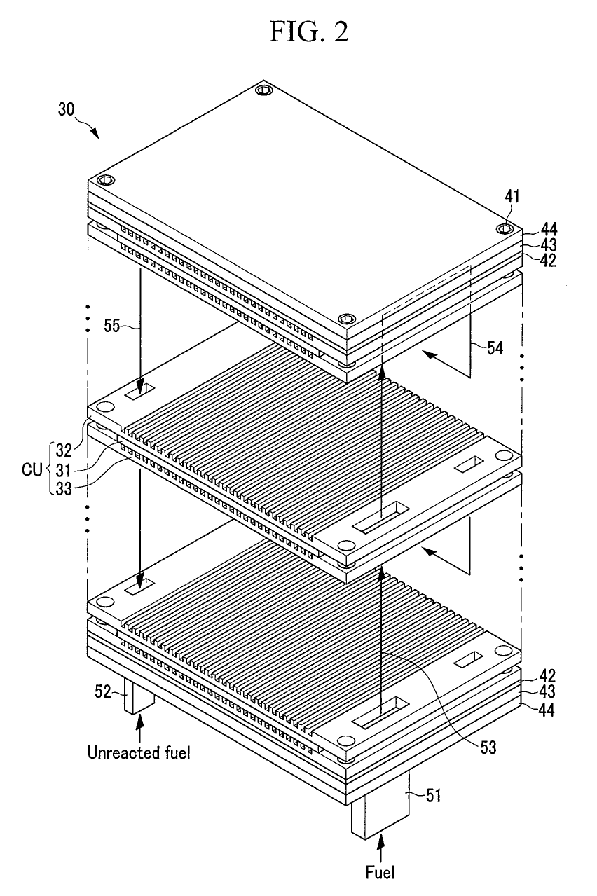

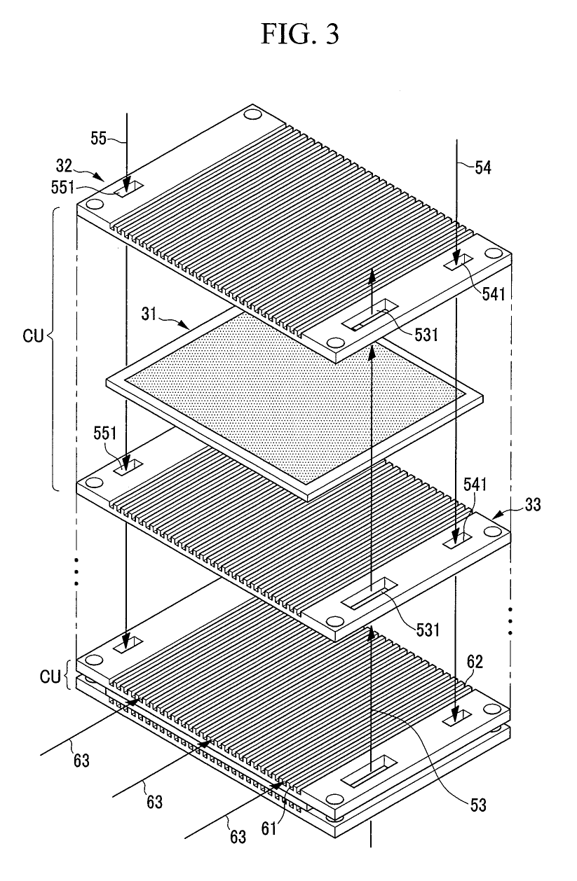

FIG. 2 is a perspective view of a portion of the stack of FIG. 1, and FIG. 3 is an exploded perspective view of a portion of the stack of FIG. 2. Referring to FIG. 1 and FIG. 2, the stack 30 may be formed by stacking a plurality of unit cells CU and fastening the outermost periphery thereof with a fastening member 41.

Each of the unit cells CU includes a membrane electrode assembly (MEA) 31, and anode-side and cathode-side separators 32 and 33 respectively disposed at both sides of the MEA 31, the separators allow the transfer of fuel and air from one side to the other side of the MEA 31. Here, the anode and the cathode are not specifically shown in the drawing. However, the anode-side separator 32 supplies a fuel to the anode of the MEA 31 and the cathode-side separator 33 supplies air to the cathode of the MEA 31. The cathode-side separator 33 and the anode-side separator 32 are disposed on opposite sides of the MEA 31.

The stack 30 is sequentially provided with a current collecting plate 42, an insulator 43, and an end plate 44 at an external side of the last or outermost unit cell in the unit cell stack provided at each side. The fastening member 41 fastens the unit cells CU, the current collecting plate 42, the insulator 43, and the end plate 44 together. In addition, the stack 30 is configured to take in the supplied fuel and air and to emit unreacted fuel and unreacted air after reaction for generation of power and heat.

For example, the stack 30 forms a fuel flow path in each of the unit cells CU with a fuel inlet 51, an unreacted fuel outlet 52, a fuel bypass path 53, a fuel distribution path 54, and an unreacted fuel inducing path 55, and forms an air flow path in each of the unit cells CU with an air inlet 61, an unreacted air outlet 62, and a reaction cooling air path 63 (refer to FIG. 1).

The fuel inlet 51 is coupled to the fuel supply 10 for inflow of the fuel to the unit cells CU in the stack 30. The unreacted fuel outlet 52 is coupled to the same side of the stack as the fuel inlet 51 and is configured to emit the unreacted fuel from the unit cells CU in the stack 30.

That is, the fuel inlet 51 and the unreacted fuel outlet 52 are coupled to the end plate 44 at one side (e.g., a low portion of the stack of FIG. 2) of the stack 30 for inflow of the fuel to the unit cells CU and emission of the unreacted fuel from the unit cells CU. Therefore, a pipe arrangement structure externally coupled to the stack 30 can be simple.

Furthermore, in the case that the fuel inlet 51 and the unreacted fuel outlet 52 are formed at the end plate 44 at the same side of the stack 30, the fuel bypass path 53, the fuel distribution path 54, and the unreacted fuel inducing path 55 can have a structure that equalizes the length of the fuel flow path formed at each of the unit cells CU to make the fuel supply amount in each of the unit cells CU uniform.

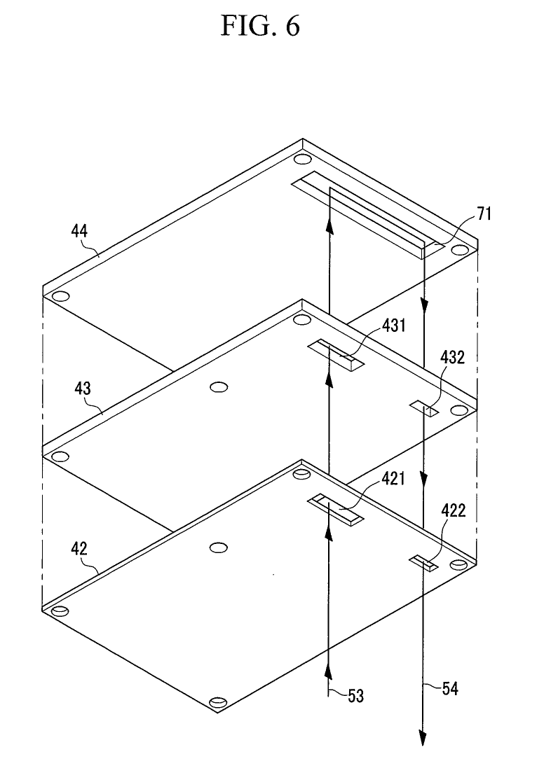

Referring back to FIG. 1 and FIG. 3, the fuel bypass path 53 extends at a end of the stack 30 from the fuel inlet 51 of the stack 30 to bypass the fuel to be at a second end of the stack 30, and penetrates all of the stacked unit cells CU. The fuel distribution path 54 is coupled to the fuel bypass path 53 at the second end of the stack 30 (refer to FIG. 6), and also penetrates all of the stacked unit cells CU. In addition, the unreacted fuel inducing path 55 extends to the unreacted fuel outlet 52 from the second end of the stack 30, and penetrates all of the stacked unit cells CU.

Therefore, the fuel bypass path 53 transfers (e.g., bypasses) the fuel supplied from the fuel inlet 51 to be at the opposite end of the stack 30. The fuel distribution path 54 is coupled to the fuel bypass path 53 and distributes the fuel to the respective unit cells CU. The unreacted fuel inducing path 55 induces unreacted fuel from the respective unit cells CU to the unreacted fuel outlet 52, and provides structure to equalize the fuel flow path lengths of the respective unit cells CU.

The stack 30, according to the first exemplary embodiment, is configured to supply air to the cathode-side separator 33 for a reaction with the fuel in the respective unit cells CU, and to form an air flow path for dissipating heat generated in the stack 30. Therefore, the stack 30 can simplify the structure of the system 100 because no additional cooling device for heat dissipation is required.

The air inlet 61 is coupled with the air supply 20 to supply air to the unit cells CU in the stack 30. The unreacted air outlet 62 is formed at a side of the stack opposite to that of the stack 30 where air inlet 61 is located and is configured to emit unreacted air from the unit cells CU in the stack 30. That is, the reaction cooling air path 63 is formed crossing the fuel bypass path 53 (i.e., the reaction cooling path is in a plane which is perpendicular to the plane of the fuel bypass and distribution), the fuel distribution path 54, and the unreacted fuel inducing path 55 that are formed parallel with each other.

In this case, the reaction cooling air path 63 extends to the unreacted air outlet 62 from the air inlet 61 to form an air flow path for heat dissipation while distributing the air for the reaction to the respective unit cells CU. Since the air flow path lengths formed in each of the unit cells CU are equal to each other, the air supply amount of the respective unit cells CU is uniform.

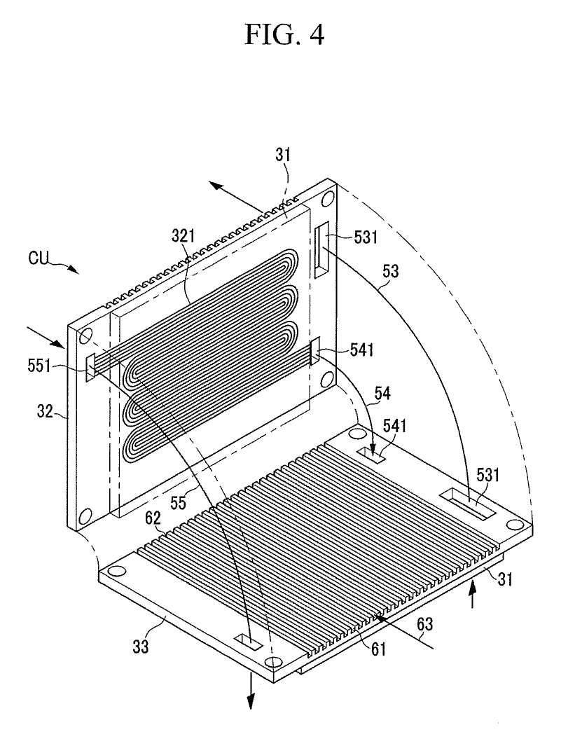

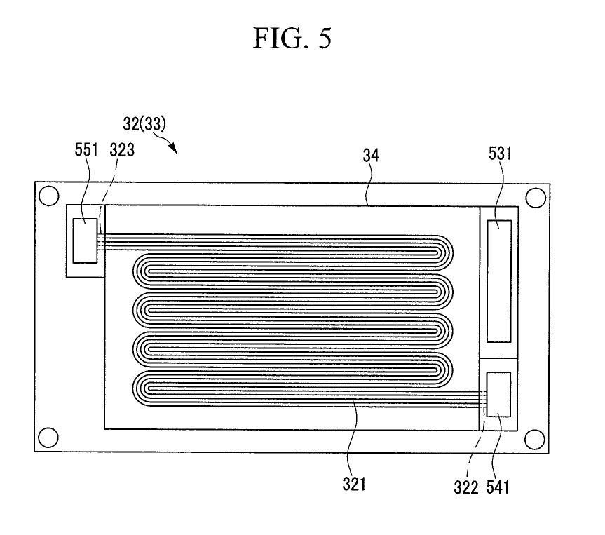

FIG. 4 is an exploded perspective view of the unit cells of a portion of the stack as shown in FIG. 2. FIG. 5 is a top plan view of a side of the separator of the unit cell, corresponding to the MEA as show in FIG. 4. FIG. 6 is an exploded perspective view of the end plate 44, the insulator 43, and the current collecting plate 42 in a portion of a stack as shown in FIG. 2.

Referring to FIG. 4 to FIG. 6, the fuel bypass path 53 is formed by a connection of fuel bypass holes 531 in the anode-side separator 32 and the cathode-side separator 33, corresponding to the outer portion of the MEA 31 (e.g., a portion of the separators that extends past the MEA.) The MEA 31 has a negligible thickness compared to the thickness of the anode-side and cathode-side separators 32 and 33. A gasket 34 (refer to FIG. 5) is disposed between the two separators 32 and 33 so that an air-tight structure is formed between the two separators 32 and 33 when the unit cells CU are formed and stacked.

The fuel distribution path 54 is formed by a connection of fuel supply holes 541 at the anode-side and cathode-side separators 32 and 33 corresponding to the outer portion of the MEA 31 (e.g., a portion of the separators that extends past the MEA.) The fuel supply holes 541 are coupled to one side of a fuel path 321 of the fuel distribution path 54 formed at the anode-side separator 32. A connector 322 (refer to FIG. 5) for the fuel supply holes 541 and the fuel path 321 is formed in a structure that maintains an airtight seal (or a hermetic seal) while crossing the gasket 34 line that air-tightly seals (or hermetically seals) the anode-side and cathode-side separators 32 and 33.

The fuel bypass path 53 and the fuel distribution path 54 are coupled to a first communication groove 71 (refer to FIG. 6) at the opposite side of the fuel inlet in order to transmit the fuel bypassed through the fuel bypass path 53 to the fuel distribution path 54. The first communication groove 71 may be formed in an end plate 44, an insulator 43, a current collecting plate 42, or a separators 32 and 33 of the last unit cell CU disposed at the opposite end of the stack as the end of the stack where the fuel inlet is disposed. For convenience, the first communication groove 71 is shown formed in the end plate 44 according to the first exemplary embodiment, as shown in FIG. 6.

The reaction cooling air path 63 is formed in or at the cathode-side separator 33. The reaction cooling air path 63 is located adjacent to the MEA 31 on the opposite side of the MEA 31 as where the fuel path 321 is located. That is, in the unit cell CU, the anode-side separator 32 corresponds to the fuel path 321 at one side of the MEA 31, and the cathode-side separator 33 corresponds to the reaction cooling air path 63 at the other side of the MEA 31. Therefore, fuel supplied through the fuel path 321 may electrochemically react with air supplied through the reaction cooling air path 63 such that power and heat are generated.

The unreacted fuel inducing path 55 is formed by connection of fuel outlet holes 551 at the anode-side and cathode-side separators 32 and 33 corresponding to the outer portion of the MEA 31. The fuel outlet holes 551 are coupled to the opposite side of the fuel supply hole 541 of the fuel path 321 formed in the anode-side separator 32. A connector 323 (refer to FIG. 5) of the fuel outlet holes 551 and the fuel path 321 is formed in a structure that maintains an airtight seal (or a hermetic seal) while crossing the gasket 34 line that air-tightly seals (or hermetically seals) the anode-side and cathode-side separators 32 and 33.

In this case, the fuel bypass path 53 is further coupled to the fuel bypass holes 531 in the anode-side and cathode-side separators 32 and 33 through fuel bypass holes 421 and 431 coupled to the current collecting plate 42 and the insulator 43. In addition, the fuel distribution path 54 is further coupled to the fuel supply holes 541 in the anode-side and cathode-side separators 32 and 33 through fuel bypass holes 422 and 432 coupled to the current collecting plate 42 and the insulator 43.

Hereinafter, a second exemplary embodiment of the present invention will be described. For brevity, a description of parts that are similar to or the same as those of the first exemplary embodiment are not repeated. The system 100, according to the first exemplary embodiment, can equalize the fuel flow path length of each of the unit cells CU while forming the fuel inlet 51 and the unreacted fuel outlet 52 in the same side of the stack 30.

An air flow path of a system 200, according to the second exemplary embodiment, differs from that of the preceding embodiment. In the second exemplary embodiment, the air inlet 261 and the unreacted air outlet 261 are formed at the same end of stack 230 to provide structure to equalize the air flow path lengths of the respective unit cells CU.

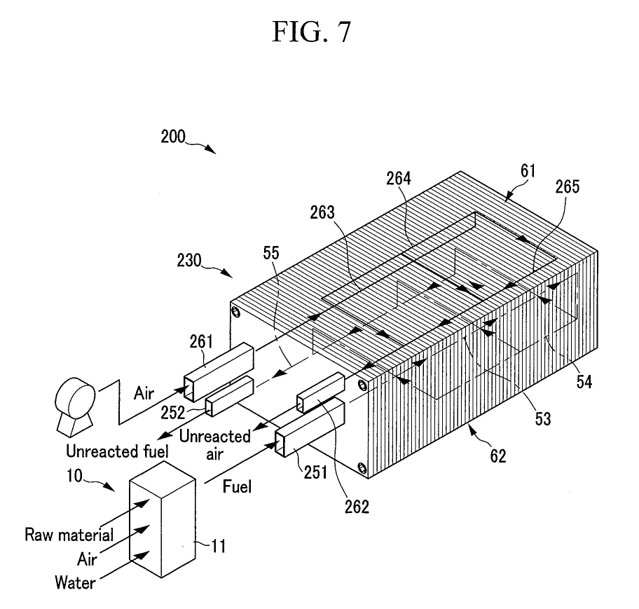

FIG. 7 is a schematic diagram of a fuel cell system according to the second exemplary embodiment of the present invention. In the second exemplary embodiment, a stack 230 includes a fuel inlet 251, an unreacted fuel outlet 252, an air inlet 261, and an unreacted air outlet 262, all formed on the same side of the stack.

The stack 230 may further include an air bypass path 263, an air distribution path 264, and an unreacted air inducing path 265 to form air flow paths in unit cells CU. The stack 230 may utilize the same or a similar fuel inlet 51, unreacted fuel outlet 52, fuel bypass path 53, fuel distribution path 54, and unreacted fuel inducing path 55 as in the first exemplary embodiment.

Additionally, the fuel path 321 of a second exemplary embodiment may be similar to the fuel flow path 321 described in the first exemplary embodiment. Furthermore, the air flow path 2331 of the second exemplary embodiment may also follow a design similar to that of the fuel flow path 321 of the first exemplary embodiment. For instance, the air inlet 261 may be coupled to an air supply 20 to take air into the stack 230, i.e., the unit cells (CU). The unreacted air outlet 262 may be coupled to the same end of the stack as which the air inlet 261 is coupled to, and may emit unreacted air from the stack 230, that is, from the unit cells CU. The air flow path and the fuel flow path can also be formed in the same direction.

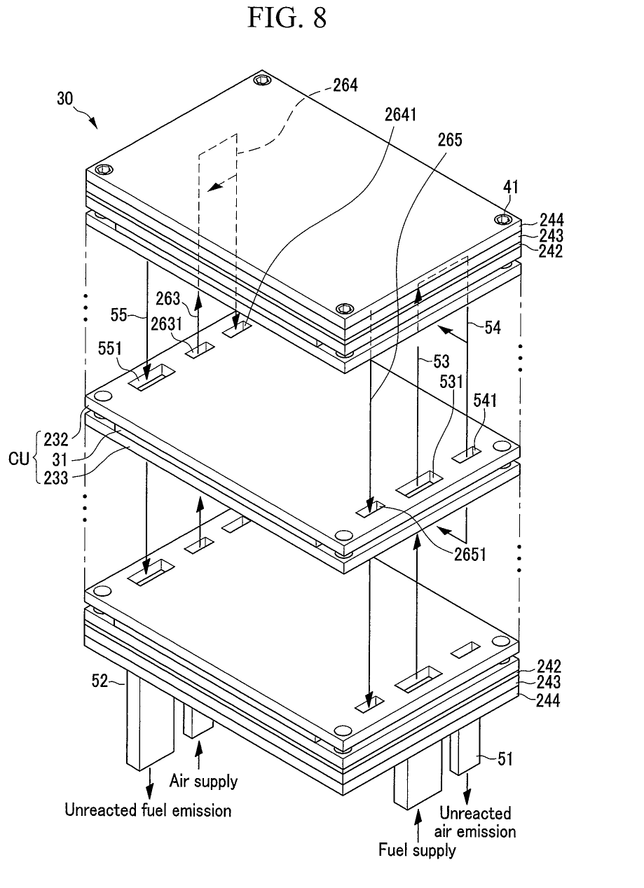

That is, the air inlet 261 and the unreacted air outlet 262 are coupled to end plates 244 provided at one end (e.g., a lower portion of the stack of FIG. 8) of the stack 230 to provide air to the unit cells CU and emit the unreacted air from the unit cells CU. Therefore, a simple pipe arrangement structure can be coupled to the stack 230.

Furthermore, the air bypass path 263, the air distribution path 264, and the unreacted air inducing path 265 can equalize air flow path lengths respectively formed in the unit cells CU even though the air inlet 261 and the unreacted air outlet 262 are formed in the same end plate 244 of the stack 230, and thereby maintain a uniform air supply amount to each of the unit cells CU.

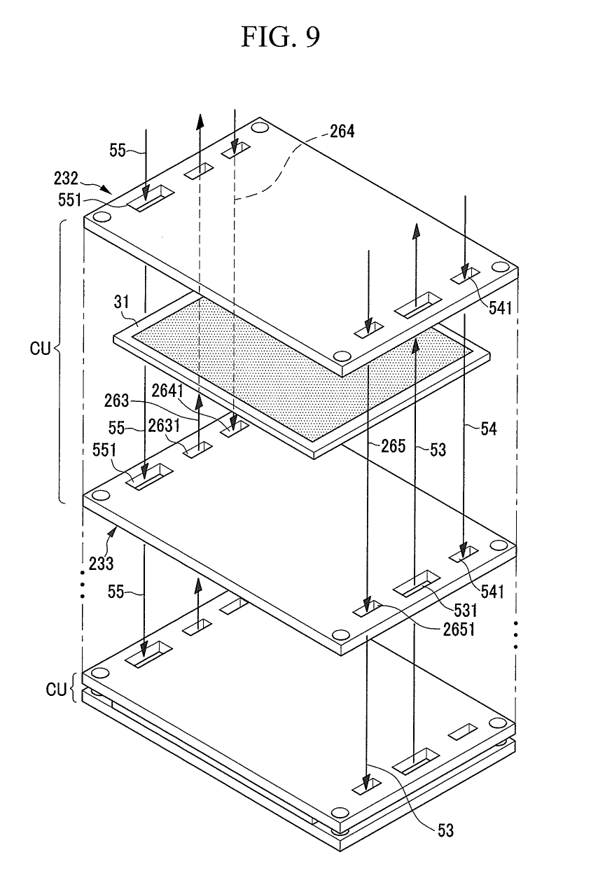

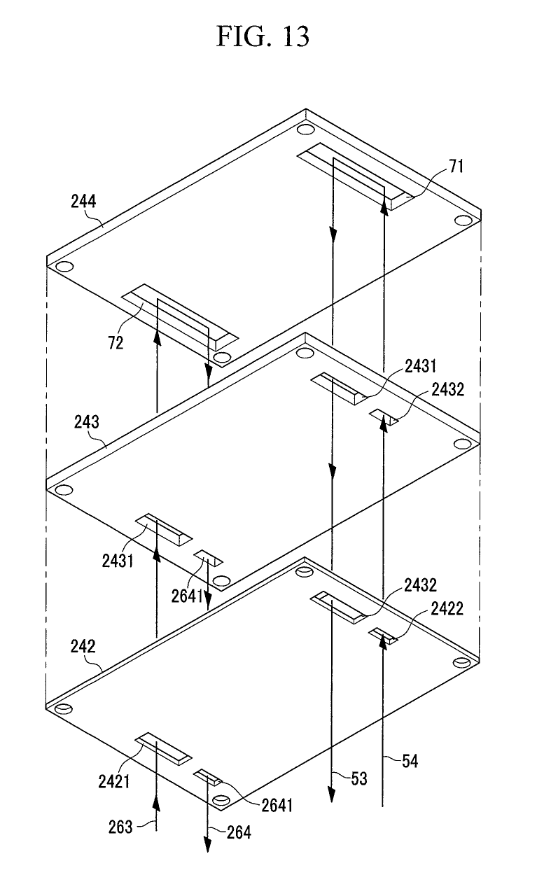

Referring back to FIG. 7 and FIG. 9, the air bypass path 263 extends from the air inlet 261 at one end of the stack 230 to the opposite end of the stack, and penetrates all the stacked unit cells CU. The air distribution path 264 is coupled to the air bypass path 263 in the communication groove 72 at the outermost unit cell of the stack (refer to FIG. 13) and extends across each of the stacked unit cells CU. In addition, the unreacted air inducing path 265 is coupled to the air distribution path 264 of each unit cell CU to the unreacted air outlet 262 to channel the unreacted air to the unreacted air outlet 262.

Therefore, the air bypass path 263 is configured to bypass air introduced from the air inlet 261 to the opposite end of the stack 230. The air distribution path 264 distributes air to the unit cells CU while heading back in the direction of the air inlet 261 from the opposite side thereof. The unreacted air inducing path 265 induces unreacted air to the unreacted air outlet 262 from the air distribution path across the cell units CU. Thus, the air flow path lengths of the respective unit cells CU can be uniform.

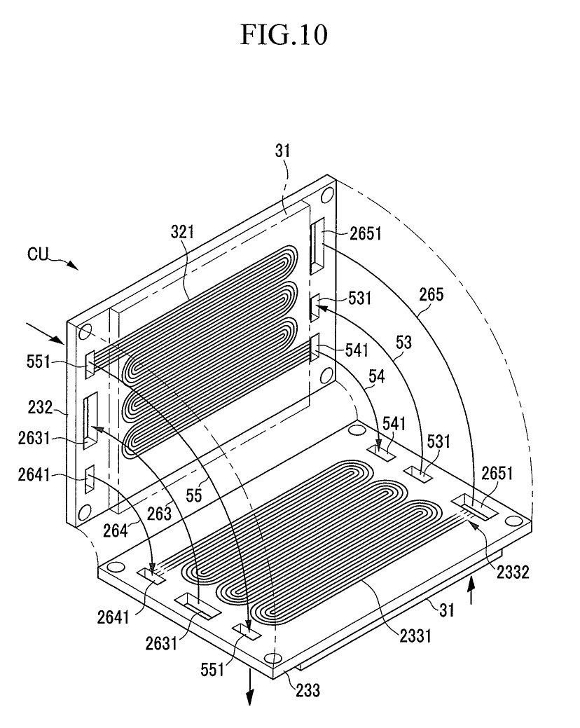

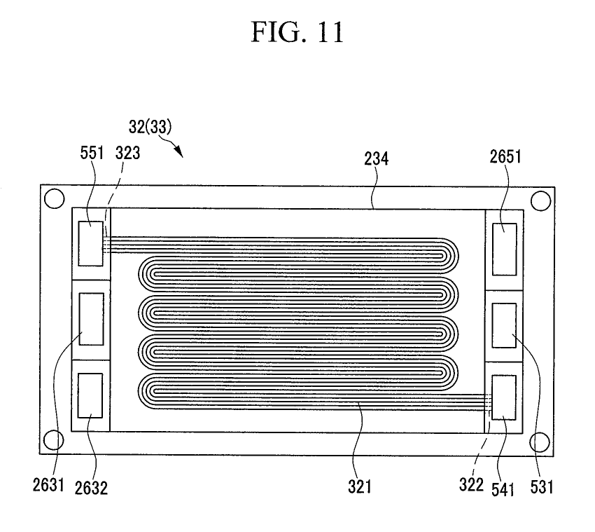

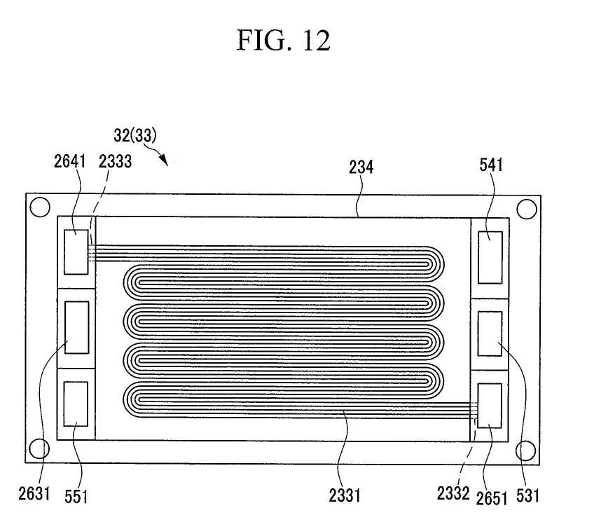

FIG. 10 is an exploded perspective view of the unit cells of a portion of the stack as shown in FIG. 8. FIG. 11 is a top plan view of a unit cell in the anode-side separator, corresponding to the MEA. FIG. 12 is a top plan view of a unit cell in the cathode-side separator, corresponding to the MEA. FIG. 13 is an exploded perspective view of an end plate, an insulator, and a current collecting plate of a portion of the stack as shown in FIG. 8.

Referring to FIG. 10 to FIG. 13, the air bypass path 263 is formed by a connection of air bypass holes 2631 formed in an anode-side separator 232 and a cathode-side separator 233 corresponding to the outer portion of the MEA 31 (e.g., a portion of the separators that extends past the MEA). The MEA 31 has a negligible thickness compared to the thickness of the anode-side and cathode-side separators 232 and 233. A gasket 234 (refer to FIG. 11 and FIG. 12) can be disposed between the two separators 232 and 233 such that an air-tight structure is formed between the two separators 232 and 233 when the unit cells CU are formed and stacked.

The air distribution path 264 is formed by a connection of air supply holes 2641 at the anode-side and cathode-side separators 232 and 233 corresponding to the outer portion of the MEA 31 (e.g., a portion of the separators that extends past the MEA). The air supply holes 2641 are coupled to one side of an air path 2331 in the cathode-side separator 233. A connector 2333 (refer to FIG. 12) for the air supply holes 2641 and the air path 2331 is formed in a structure that maintains an airtight seal (or a hermetic seal) while crossing the gasket 234 line that air-tightly seals (or hermetically seals) the anode-side and cathode-side separators 232 and 233.

With respect to FIG. 13, the air bypass path 263 and the air distribution path 264 are coupled to a second communication groove 72 at the opposite side of the air inlet in order to transmit the air bypassed through the air bypass path 263 to the air distribution path 264. The second communication groove 72 may be formed in an end plate 244, an insulator 243, a current collecting plate 242, or the separators 232 and 233 of the last unit cell CU. For convenience, the first and second communication grooves 71 and 72, according to the second exemplary embodiment, are shown as formed at the end plate 244.

The unreacted air inducing path 265 is formed by a connection of air outlet holes 2651 formed at the anode-side and cathode-side separators 232 and 233 corresponding to the outer portion of the MEA 31. The air outlet holes 2651 are coupled to an opposite side of the air supply hole 2641 of the air path 2331 formed in the cathode-side separator 233. Connectors 2332 and 2333 (refer to FIG. 12) of the air outlet holes 2651 and the air path 2331 are formed in a structure that maintains an airtight seal (or a hermetic seal) while crossing the gasket 234 line which provides an airtight seal (or a hermetic seal) for the anode-side and cathode-side separators 232 and 233.

In this case, the air bypass path 263 is further coupled to air bypass holes 2631 formed in the anode-side and cathode-side separators 232 and 233 through air bypass holes 2421 and 2431 coupled to the current collecting plate 242 and the insulator 243. In addition, the air distribution path 264 is further coupled to air supply holes 2641 formed in the anode-side and cathode-side separators 232 and 233 through the air bypass holes 2421 and 2431 coupled to the current collecting plate 242 and the insulator 243.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Connected holes (e.g. fuel or air bypass and fuel or air supply holes) may also be formed and connected in a portion of the separator corresponding to an outer portion of the MEA.

What is claimed is:

1. A fuel cell system comprising:
a fuel supply configured to supply a fuel containing hydrogen;
an air supply configured to supply air containing oxygen; and
a stack configured to generate power and heat through an electrochemical reaction of the hydrogen and the oxygen,
wherein the stack comprises:
a plurality of unit cells stacked together, and each unit cell of the plurality of unit cells comprises separators and a membrane assembly (MEA) disposed between the separators;
a fuel inlet coupled to the fuel supply at a first end of the stack, the fuel inlet configured to introduce the fuel to the plurality of the unit cells;
an unreacted fuel outlet at the first end of the stack, the unreacted fuel outlet configured to emit unreacted fuel from the stack;
a fuel bypass path coupled to the fuel inlet, the fuel bypass path configured to bypass the fuel from the first end of the stack to be at a second end of the stack;
a fuel distribution path coupled to the fuel bypass path at the second end of the stack and configured to distribute the fuel to the plurality of unit cells; and
an unreacted fuel inducing path coupled between the fuel distribution path and the unreacted fuel outlet, the unreacted fuel path configured to channel the unreacted fuel to the unreacted fuel outlet.

2. The fuel cell system of claim 1, wherein the fuel bypass path is formed by a connection of fuel bypass holes in a portion of the separators that extends past the MEA.

3. The fuel cell system of claim 1, wherein the fuel distribution path is formed by a connection of fuel supply holes in a portion of the separators that extends past the MEA, and the fuel supply holes are coupled to a first side of fuel paths of the separators.

4. The fuel cell system of claim 3, wherein the unreacted fuel inducing path is formed by a connection of fuel outlet holes in the portion of the separators that extends past the MEA, and the fuel outlet holes are coupled to a second side of the fuel paths of the separators.

5. The fuel cell system of claim 1, wherein the fuel bypass path and the fuel distribution path are coupled together through a first communication groove in at least one of an end plate, an insulator, a current collecting plate, and a separator in the an outermost unit cell of the plurality of unit cells at the second end of the stack.

6. The fuel cell system of claim 1, wherein the stack further comprises:
an air inlet configured to introduce air to the plurality of unit cells from the air supply;
an unreacted air outlet located at a side of the stack opposite to a side of the stack where the air inlet is located; and
a reaction cooling air path extending between the air inlet and the unreacted air outlet, the reaction cooling air path configured to distribute the unreacted air to the unit cells and form air flow paths for heat dissipation.

7. The fuel cell system of claim 6, wherein the reaction cooling air path is formed to extend in a direction crossing the extension direction of the fuel bypass path.

8. The fuel cell system of claim 6, wherein the reaction cooling air path is on a side of a corresponding separator of the separators opposite to a side of the corresponding separator disposed thereon by a fuel path.

9. The fuel cell system of claim 6, wherein, a first separator of the separators of each unit cell comprises a fuel path adjacent to one side of the MEA, and a second separator of the separators comprises the reaction cooling air path adjacent to another side of the MEA.

10. A fuel cell system comprising:
a fuel supply configured to supply a fuel containing hydrogen;
an air supply configured to supply air containing oxygen; and
a stack configured to generate power and heat through an electrochemical reaction of the hydrogen and the oxygen,
wherein the stack comprises:
a plurality of unit cells stacked together, and each of the plurality of unit cells comprises separators and a membrane assembly (MEA) disposed between the separators;
a fuel inlet coupled to the fuel supply, the fuel inlet configured to introduce the fuel to the plurality of unit cells;
an unreacted fuel outlet configured to emit unreacted fuel from the stack;
an air inlet coupled to the air supply, the air inlet configured to introduce the air from the air supply to the plurality of unit cells; and
an unreacted air outlet configured to emit unreacted air from the stack, wherein the fuel inlet, the unreacted fuel outlet, the air inlet, and the unreacted air outlet are formed at a first end of the stack;
a fuel bypass path coupled to the fuel inlet, the fuel bypass path configured to bypass the fuel from the first end of the stack to be at a second end of the stack;
a fuel distribution path coupled to the fuel bypass path at the second end of the stack, and configured to distribute the fuel to each of the plurality of unit cells; and
an unreacted fuel inducting path coupled between the fuel distribution path and the unreacted fuel outlet, the unreacted fuel path configured to channel the unreacted fuel to the unreacted fuel outlet.

11. The fuel cell system of claim 10, wherein the stack further comprises:
an air bypass path coupled to the air inlet, the air bypass path configured to bypass the air from the first end of the stack to be at the second end of the stack;
an air distribution path coupled to the air bypass path at the second end of the stack, the air distribution path configured to distribute air to each of the plurality unit cells; and
an unreacted air inducing path coupled between the air distribution path and the unreacted air outlet, the unreacted air inducing path configured to channel the unreacted air to the unreacted air outlet.

12. The fuel cell system of claim 11, wherein the fuel bypass path comprises a connection of fuel bypass holes in portions of the separators that extend past the MEA, and the air bypass path comprises a connection of air bypass holes in portions of the separators that extend past the MEA.

13. The fuel cell system of claim 11, wherein the fuel distribution path is formed by a connection of fuel supply holes in a portion of the separators that extend past the MEA, and the fuel supply holes are coupled to a first side of fuel paths of the separators.

14. The fuel cell system of claim 13, wherein the unreacted fuel inducing path is formed by a connection of fuel outlet holes in the portion of the separators that extends past the MEA, and the fuel outlet holes are coupled to a second side of the fuel paths of the separators.

15. The fuel cell system of claim 11, wherein the air distribution path is formed by a connection of air supply holes in a portion of the separators that extends past the MEA, and the air supply holes are coupled to a first side of air paths in the separators.

16. The fuel cell system of claim 15, wherein the unreacted air inducing path is formed by a connection of air outlet holes in the portion of the separators that extends past the MEA, and the air outlet holes are coupled to a second side of the air paths in the separators.

17. The fuel cell system of claim 10, wherein the air bypass path and the air distribution path are coupled together through a second communication groove formed in at least one of an end plate, an insulator, a current collecting plate, and a separator in an outermost unit cell of the plurality of unit cells at the second end of the stack.

18. A fuel cell system comprising:
a plurality of unit cells stacked together, each of the plurality of unit cells comprising separators and a membrane assembly (MEA) disposed between the separators;
a fuel inlet coupled to a first end of the stack and configured to introduce a fuel containing hydrogen to the unit cells;
an unreacted fuel outlet coupled to the first end of the stack and configured to emit unreacted fuel from the unit cells;
a fuel bypass path coupled to the fuel inlet, the fuel bypass path configured to bypass the fuel from the first end of the stack to be at a second end of the stack;
a fuel distribution path coupled to the fuel bypass path at the second end of the stack and configured to distribute the fuel to the plurality of unit cells; and
an unreacted fuel inducing path coupled between the fuel distribution path and the unreacted fuel outlet, the unreacted fuel path configured to channel the unreacted fuel to the unreacted fuel outlet.

19. The fuel cell system of claim 18, wherein the fuel bypass path comprises a connection of fuel bypass holes in a portion of the separators that extends past the MEA.

20. The fuel cell system of claim 18, wherein the fuel distribution path comprises a connection of fuel supply holes in a portion of the separators that extends past the MEA, and the fuel supply holes are coupled to a first side of fuel paths of the separators.

21. The fuel cell system of claim 20, wherein the unreacted fuel inducting path is formed by a connection of fuel outlet holes in the portion of the separators that extends past the MEA, and the fuel outlet holes are coupled to a second side of the fuel paths of the separators.

22. The fuel cell system of claim 18, wherein the fuel bypass path and the fuel distribution path are coupled together through a first communication groove in at least one of an end plate, an insulator, a current collecting plate, and a separator in the an outermost unit cell of the plurality of unit cells at the second end of the stack.

23. The fuel cell system of claim 18, wherein the stack further comprises:
an air inlet configured to introduce air to the plurality of unit cells from the air supply;
an unreacted air outlet located at a side of the stack opposite to a side of the stack where the air inlet is located; and
a reaction cooling air path extending between the air inlet and the unreacted air outlet, the reaction cooling air path formed in the crossing direction of the fuel bypass path and configured to distribute the unreacted air to the unit cells and form air flow paths for heat dissipation.

24. A fuel cell system comprising:
a stack configured to generate power and heat through an electrochemical reaction of the hydrogen and the oxygen, the stack comprising:
a plurality of unit cells stacked together, and each of the plurality of unit cells comprises separators and a membrane assembly (MEA) disposed between the separators;
a fuel inlet coupled to the fuel supply, the fuel inlet configured to introduce a fuel to the plurality of unit cells;
an unreacted fuel outlet configured to emit unreacted fuel from the stack;
an air inlet coupled to the air supply, the air inlet configured to transfer air from the air supply to the unit cells; and
an unreacted air outlet configured to emit unreacted air from the stack, wherein the fuel inlet, the unreacted fuel outlet, the air inlet, and the unreacted air outlet are formed at a first end of the stack;
a fuel bypass path coupled to the fuel inlet, the fuel bypass path configured to bypass the fuel from the first end of the stack to be at a second end of the stack;
a fuel distribution path coupled to the fuel bypass path at the second end of the stack, and configured to distribute the fuel to each of the plurality of unit cells; and
an unreacted fuel inducing path coupled to the fuel distribution path and the unreacted fuel outlet, the unreacted fuel inducing path configured to channel the unreacted fuel to the unreacted fuel outlet.

25. The fuel cell system of claim 24, further comprising:
an air bypass path coupled to the air inlet, the air bypass path configured to bypass the air from the first end of the stack to be at the second end of the stack;
an air distribution path coupled to the air bypass path at the second end of the stack, the air distribution path configured to distribute air to each of the plurality of unit cells; and
an unreacted air inducing path coupled between the air distribution path and the unreacted air outlet, the unreacted air inducing path configured to channel the unreacted air to the unreacted air outlet.

26. The fuel cell system of claim 25, wherein the fuel bypass path comprises a connection of fuel bypass holes in portions of the separators that extend past the MEA and the air bypass path comprises a connection of air bypass holes in portions of the separators that extend past the MEA.

27. The fuel cell system of claim 25, wherein
the fuel distribution path is formed by a connection of fuel supply holes in a portion of the separators that extends past the MEA,
the fuel supply holes are coupled to a first side of fuel paths of the separators,
the unreacted fuel inducing path is formed by a connection of fuel outlet holes in the portion of the separators that extends past the MEA, and
the fuel outlet holes are coupled to a second side of the fuel paths of the separators.

28. The fuel cell system of claim 25, wherein
the air distribution path is formed by a connection of air supply holes in a portion of the separators that extends past the MEA,
the air supply holes are coupled to a first side of air paths of the separators,
the unreacted air inducing path is formed by a connection of air outlet holes in the portion of the separators that extends past the MEA, and
the air outlet holes are coupled to a second side of the air paths in the separators.

29. The fuel cell system of claim 25, wherein the air bypass path and the air distribution path are coupled through a second communication groove formed in at least one of an end plate, an insulator, a current collecting plate, and a separator in an outermost unit cell of the plurality of unit cells at the second end of the stack.
